(19) United States
(12) Patent Application Publication
(10) Pub. No.: US 2019/0053420 A1
(43) Pub. Date: Feb. 21, 2019

(54) SYSTEMS AND METHODS FOR PLANTING A FIELD WITH TWO CROPS

(71) Applicant: The 100$100 Systems, LLC, Leesburg, VA (US)

(72) Inventor: James Bates, Leesburg, VA (US)

(73) Assignee: The 100$100 Systems, LLC, Leesburg, VA (US)

(21) Appl. No.: 16/144,516

(22) Filed: Sep. 27, 2018

Related U.S. Application Data
(63) Continuation of application No. PCT/US17/42778, filed on Jul. 19, 2017.
(60) Provisional application No. 62/376,798, filed on Aug. 18, 2016.

(51) Int. Cl. A01C 7/18; A01C 7/04; A01C 21/00

(52) U.S. Cl. CPC A01C 7/18; A01C 21/005; A01C 7/04

(57) ABSTRACT

A method for planting a field with a seed planter is provided. The method includes moving the seed planter across the field such that the seeds of a first seed type and seeds of a second seed type are both dispensed in a single row. According to this embodiment, a first seed disc of the seed planter is configured to dispense seeds of the first seed type equidistant relative to adjacent seeds of the first seed type, and a second seed disc is configured to dispense the seeds of the second seed type not equidistant relative to adjacent seeds of the second seed type.

### CROSS REFERENCE TO RELATED APPLICATIONS

This application is a bypass continuation of International Application No, PCT/US17/42778 filed Jul. 19, 2017, which claims the benefit of U.S. Provisional Application No. 62/376,798 filed Aug. 18, 2016, both of which are herein incorporated by reference in their entirety.

### TECHNICAL FIELD

The present disclosure relates generally to systems and methods for planting a field with two crops using a seed planter.

### BACKGROUND

Advances in modern farming practices have increased the yield, quality, and profitability of agricultural crops. Intercropping is one such advance that involves growing two different crops in close proximity to one another. The advantages of intercropping include increased crop density, improved soil quality, and light interception for less heat-tolerant plants. Both row intercropping—in which two different crops are planted in alternating rows—and mixed intercropping—in which two different crops are planted in the same row—are viable intercropping techniques, but mixed intercropping of tall, heat-resistant plants with short, heat-intolerant plants is especially desirable in warmer agricultural climates. In such cases, it is particularly desirable that the tall, heat-resistant plants are distributed throughout the field such that they provide maximum shade coverage for the short, heat-intolerant plants.

Mixed intercropping requires the use of systems and methods capable of depositing two different types of seeds into the same row of soil. Such devices are described in, for example, U.S. Patent Application Publication 2016/0128267 filed Sep. 29, 2015 and published May 12, 2016 and U.S. Patent Application Publication 2014/0277959 filed Mar. 15, 2013 and published Sep. 18, 2014, which both describe seed planters for depositing two different types of seeds.

In each of these disclosures, seeds of both types are deposited into the soil at equidistant intervals unless the planting characteristics of the seed planter are manually altered using complex mechanical or electrical systems. For example, U.S. Patent Application Publication 2016/0128267 describes the use of a clutch and motor assembly to selectively drive two seed dispensing elements. U.S. Patent Application Publication 2014/0277959 describes the use of an electronic control system to remotely adjust planting characteristics. The use of complex systems to dynamically control planting characteristics increases the expense of acquiring, operating, and maintaining seed planters, and requires the user to closely monitor the seed planter to change planting characteristics when necessary.

There remains a need for simplified systems and methods of planting a field with two different crops, wherein the positions of one of the crops within a row of the field are different from the positions of that crop in adjacent rows. Disclosed herein are one or more systems and methods that advantageously address these issues.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a method for planting a field with a seed planter is provided. The method includes moving the seed planter across the field such that the seeds of a first seed type and seeds of a second seed type are both dispensed in a single row. According to this embodiment, a first seed disc of the seed planter is configured to dispense seeds of the first seed type equidistant relative to adjacent seeds of the first seed type, and a second seed disc is configured to dispense the seeds of the second seed type not equidistant relative to adjacent seeds of the second seed type.

According to at least another embodiment, a method for planting a field with a seed planter is provided. The method includes: affixing a rotatable first seed disc to a first seed meter, the first seed disc defining a plurality of first seed pockets circumferentially disposed and proximate an outer edge thereof, wherein the plurality of first seed pockets are equidistantly spaced relative to adjacent first seed pockets; affixing a rotatable second seed disc to a second seed meter, the second seed disc defining a plurality of second seed pockets circumferentially disposed and proximate an outer edge thereof, wherein the plurality of second seed pockets are not equidistantly spaced relative to adjacent second seed pockets; placing the seeds of a first seed type in the first seed meter; placing the seeds of a second seed type in the second seed meter; moving the seed planter across the field such that both seed types are dispensed in a single row.

According to at least another embodiment, a method of planting a field with a seed planter is provided. The method includes: dispensing seeds of a first seed type into a cultivated row with a first seed meter that defines a plurality of first seed pockets for receiving the seeds of a first seed type to be dispensed and dispensing seeds of a second type into the cultivated row with a second seed meter that defines a plurality of second seed pockets for receiving the seeds of a second type to be dispensed. According to this embodiment, at least one of the second seed pockets is differently spaced-apart from a next radially-spaced second seed pocket in a first radial direction than a next radially-spaced seed pocket in a second radial direction opposite the first radial direction.

According to another embodiment, the methods of this invention may further include moving the seed planter across the field a plurality of times for creating plurality of cultivated rows.

According to another embodiment, the seeds of a second type are dispensed into positions within each of the plurality of cultivated rows and the positions vary amongst the plurality of cultivated rows.

According to at least another embodiment, a system for planting a field is provided. The system includes a seed planter with a first seed meter and a second seed meter, the first seed meter including a first seed disc with a plurality of seed pockets circumferentially disposed proximate an outer edge of the first seed disc, wherein the plurality of first seed pockets are equidistantly spaced relative to adjacent first seed pockets, and the second seed meter including a second seed disc with a plurality of second seed pockets circumferentially disposed proximate an outer edge of the second seed disc, wherein the plurality of second seed pockets are not equidistantly spaced relative to the adjacent second seed pockets. According to this embodiment, the seed planter of the system is further configured to dispense the plurality of seeds of a first seed type from the first seed disc and the plurality of seeds of a second type from the second seed disc in a single row.

According to at least another embodiment, a system for planting a field is provided. The system includes a first seed meter for dispensing seeds of a first seed type into a cultivated row, the first seed meter defining a plurality of first seed pockets for receiving the seeds of a first seed type, and a second seed meter for dispensing seeds of a second type into the cultivated row, the second seed meter defining a plurality of second seed pockets for receiving the seeds of a second type. According to this embodiment, at least one of the second seed pockets is differently spaced-apart from a next radially-spaced second seed pocket in a first radial direction than a next radially-spaced seed pocket in a second radial direction opposite the first radial direction.

According to another embodiment, the systems of this invention may further include a first seed receptacle for housing the seeds of a first seed type, wherein the first seed disc is rotatably affixed to the first seed receptacle.

According to another embodiment, the systems of this invention may further include a second seed receptacle for housing the seeds of a second seed type, wherein the second seed disc is rotatably affixed to the second seed receptacle.

According to another embodiment, the systems and methods of the present invention may be practiced such that seeds of a first type are short, heat-intolerant plants, and seeds of a second type are tall, heat-resistant plants.

According to another embodiment, the systems and methods of the present invention may be practiced such that the seeds of a first type are soybean seeds, and the seeds of a second type are corn seeds.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1A is a side view of the first seed disc according to one or more embodiments of the present invention.

FIGS. 1B and 1C are side views of the second seed disc according to one or more embodiments of the present invention.

FIG. 2 is an illustration of a seed disc in operation according to one or more embodiments of the present invention.

FIG. 3 is a schematic view of the seed planter according to one or more embodiments of the present invention.

FIG. 4 is a birds-eye view of a plurality of rows according to one or more embodiments of the present invention.

FIG. 5 is an illustrated side view of a row according to one or more embodiments of the present invention.

FIG. 6 is an illustrated perspective view of a unitarily-formed seed disc according to one or more embodiments of the present invention.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

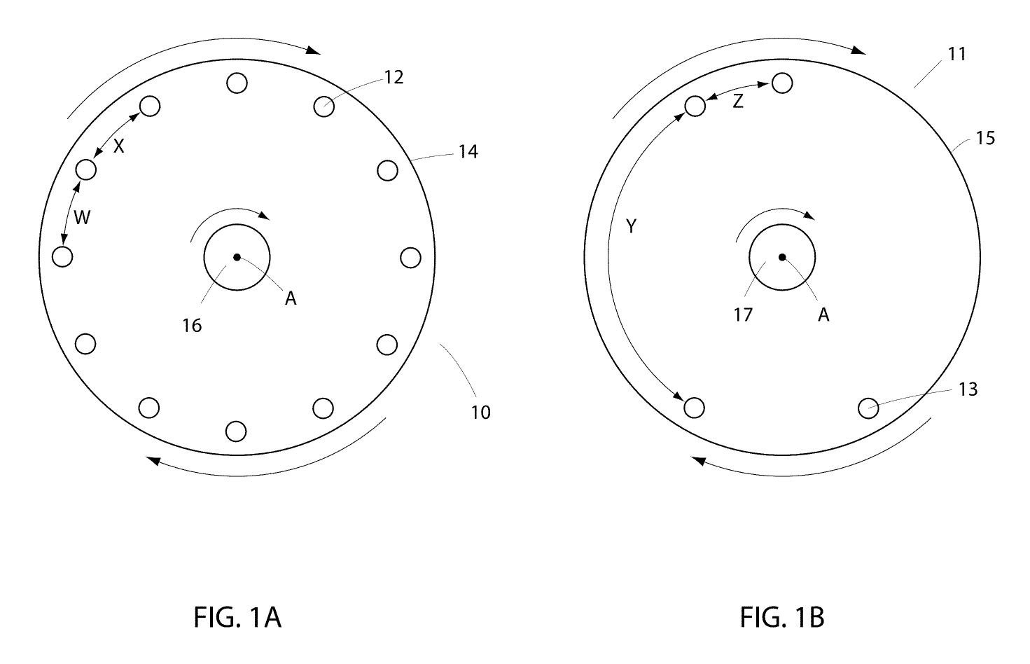

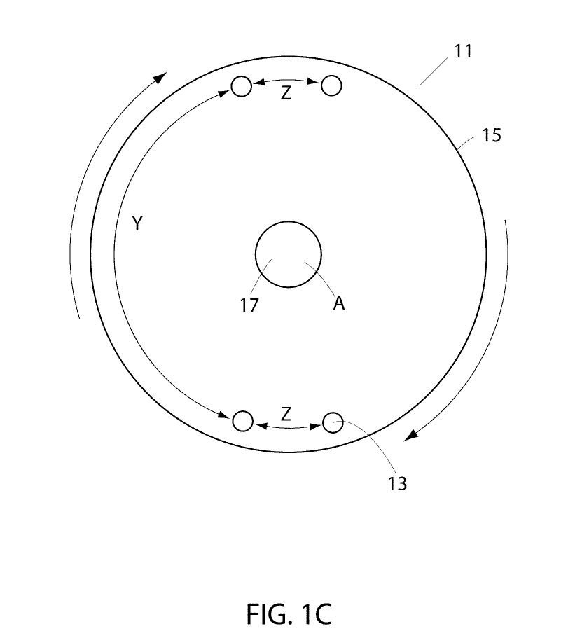

Referring now to FIGS. 1A-1C, seed discs according to at least one embodiment of the present invention are shown. First seed disc 10 and second seed disc 11 can be substantially circular discs made of a rigid material, preferably steel or some other type of metal. First seed disc 10 may include a plurality of first seed pockets 12 disposed circumferentially around the first seed disc 10 proximate an outer edge 14 of the first seed disc 10. Each of the plurality of first seed pockets 12 are equidistantly spaced relative to adjacent first seed pockets 12. Second seed disc 11 may include a plurality of second seed pockets 13 disposed circumferentially around the second disc 11 proximate an outer edge 15 of the second seed disc 11. Each of the plurality of second seed pockets 13 are not equidistantly spaced relative to adjacent second seed pockets 13.

By way of example, for any given first seed pocket 12, the arc lengths W and X to the two adjacent first seed pockets 12 may be equivalent in the first seed disc 10. For any given second seed pocket 13, the arc lengths Y and Z to the two adjacent second seed pockets 13 are not equivalent in the second seed disc 11. The seed pockets 13 of the second seed disc 11 may be precisely spaced about the circumference of the seed disc 11, but the distance between the seed pockets 13 may differ from pocket 13 to pocket 13.

Connection points 16 and 17 at the center of each seed disc may be used to couple first seed disc 10 and second seed disc 11 to seed planters. In some embodiments, the connection points 16 and 17 may be uniquely shaped cutouts in the center of the seed discs designed to engage corresponding structures in seed planters. In yet other embodiments, the connection points 16 and 17 may be a plurality of holes for coupling the seed discs to the seed planter with screws or bolts.

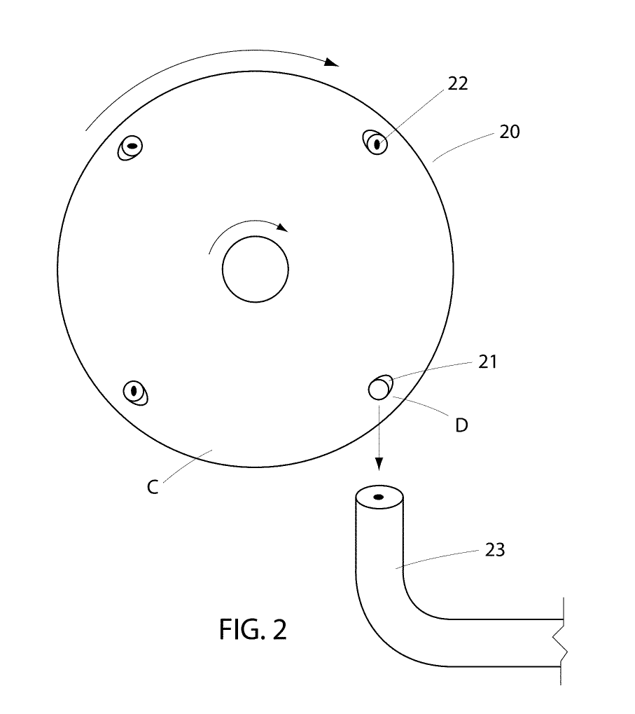

Referring now to FIG. 2, an illustration of a seed disc 20 in operation is shown. As the seed disc rotates clockwise, seed pockets 21 pass through point C. At point C, a seed 22 can adhere to seed pockets 21 through mechanical or pneumatic means, both of which are well known in the art. Seeds can be sent to point C through the use of a conveyor belt or a seed reservoir may be present at point C. At point D, seed 22 may be released from seed pocket 21 and sent to subsequent systems 23 in the planter configured to dispense the seed into a single row in the soil.

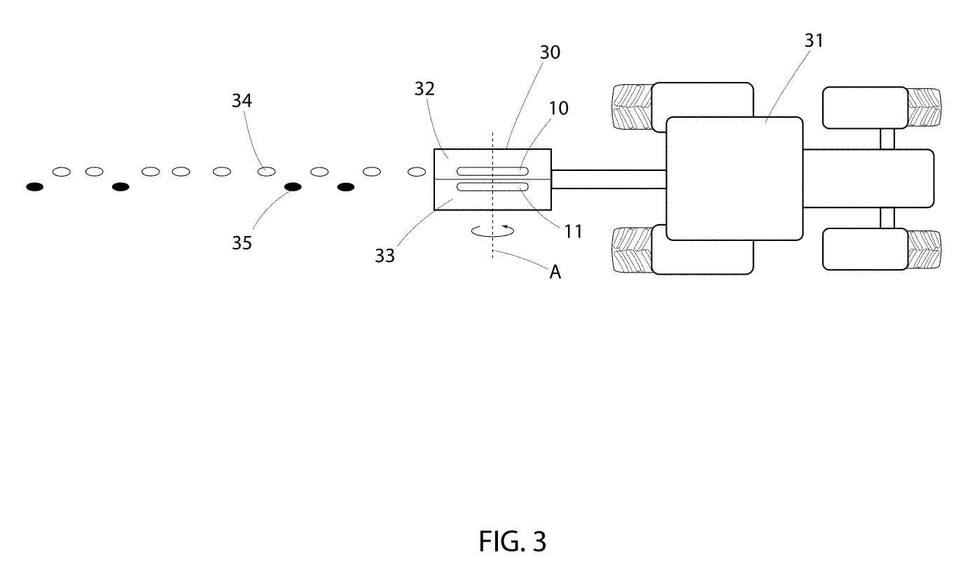

Referring now to FIG. 3, a schematic diagram of a seed planter 30 is shown. A seed planter 30 may be coupled to a tractor 31, which moves the seed planter 30 across the field. The seed planter 30 can contain a first seed meter 32 for dispensing seeds of a first seed type 34 into a row and a second seed meter 33 for dispensing seeds of a second type 35 into the same row. Seeds of a first seed type 34 and seeds of a second type 35 may be placed in the first seed meter 32 and second seed meter 33, respectively, before the seed planter 30 is moved across the field. In other embodiments, seeds of a first seed type 34 and seeds of a second type 35 stored in the seed planter 30 may be fed to the first seed meter 32 and second seed meter 33, respectively, as the seed planter 30 is moved across the field.

The first seed meter 32 may include a first seed disc 10 which rotates about axis A. The second seed meter 33 may include a second seed disc 11 which also rotates about axis A. Seed planter 30 can be configured according to methods known in the art to receive seeds of a first seed type 34 and seeds of a second type 35 from first seed disc 10 and second seed disc 11, respectively, and to dispense the seeds into a single row. In alternative embodiments, the first seed disc 10 and/or the second seed disc 11 may be angled such that each disc 10, 11 rotates about an independent, non-parallel axis.

As the seed planter moves across the field, the first seed disc 10 causes seeds of a first seed type 34 to be deposited at equidistant intervals within the row. The second seed disc 11 causes seeds of a second type 35 to be deposited at non-equidistant intervals in between the seeds of a first seed type 34 within the same row. While both seed types 34, 35 are planted into a single row, placement of the first seed type 34 may be biased towards one side of the row and placement of the second seed type 35 may be biased towards an opposite side of the row. In some embodiments, seed type 34 and seed type 35 may be spaced apart a certain distance. The distance may be eight to ten inches in some embodiments. The space between rows of seed types 34, 35 may also be a certain row distance apart. The row distance may be twenty to forty-eight inches apart in some embodiments. In other embodiments, the row distance may be thirty inches between the center of each row.

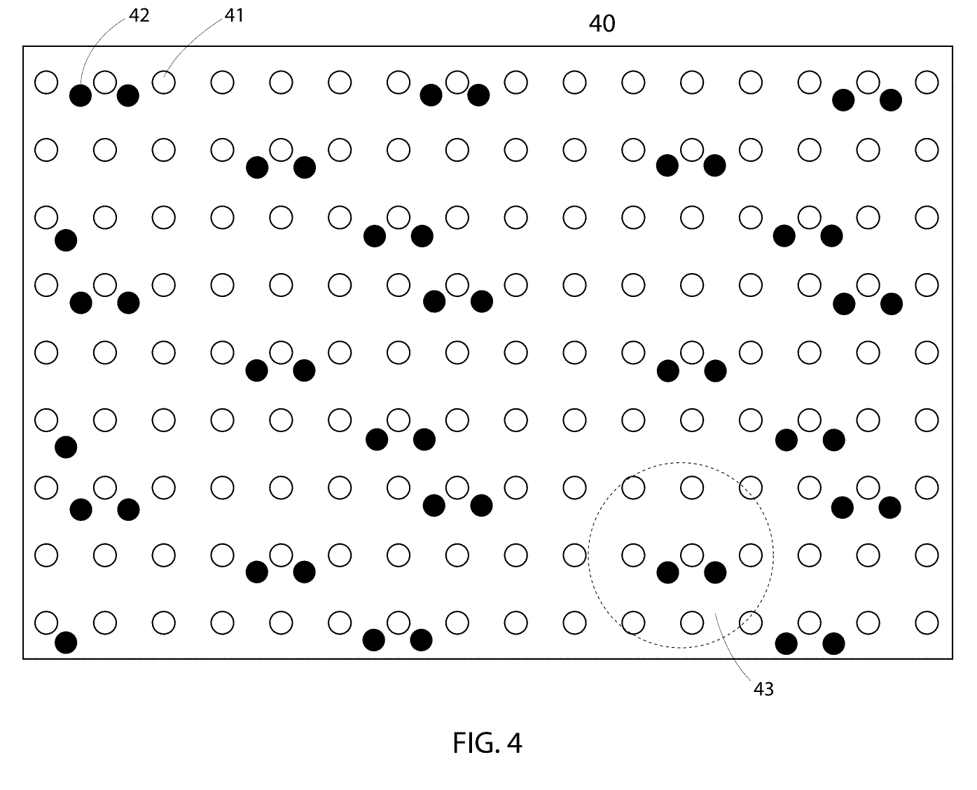

In some embodiments, the seed planter 30 may include wheels and an optional motor that allow the seed planter 30 to move across the field without an extraneous device such as tractor 31. The planter 30 may include a twin-row planter, may include mechanical, hydraulic or electrically driven planters, high-speed planters and other planters. Twin-row planters may be provided for planting both seed types 34, 35 within a single row unit while being spaced apart within the row unit. For example, the first seed type 34 may be biased to the left of the row unit and the second seed type 35 may be biased to the right of the row unit, with the two seed types 34, 35 being spaced approximately the same distance apart within the row unit and each row unit being spaced a greater distance apart from each other (FIG. 4). In other embodiments, the planter 30 may include a plurality of seed discs 10, 11 for planting two, three or any number of rows simultaneously.

In at least one embodiment of the present invention, the method of planting a field with seed planter 30 may include moving the seed planter 30 across the field such that seeds of a first seed type 34 and seeds of a second seed type 35 are both dispensed into a single row, or dispensed into each row of multiple rows simultaneously. A first seed disc 10 of the seed planter 30 may be configured to dispense seeds of the first seed type 34 equidistant relative to adjacent seeds of the first seed type 34, and a second seed disc 11 may be configured to dispense the seeds of the second seed type 35 not equidistant relative to adjacent seeds of the second seed type 35. Referring to FIGS. 1C and 4, at least one embodiment of the present invention includes twin-planting the second seed type 35, which permits the population of the second seed type 35 to be high enough for harvesting a minimum yield, while also permitting enough light to reach the plants of the first seed type 34 for effective growth.

Referring now to FIGS. 1A-3, in at least another embodiment of the present invention, the method of planting a field with a seed planter 30 may include affixing a rotatable first seed disc 10 to a first seed meter 32. The first seed disc 10 may have a plurality of first seed pockets 12 circumferentially disposed and proximate an outer edge 14 of the first seed disc 10. The plurality of first seed pockets 12 may be equidistantly spaced relative to adjacent first seed pockets 12. The method may further include affixing a rotatable second seed disc 11 to a second seed meter 33. The second seed disc 11 may have a plurality of second seed pockets 13 circumferentially disposed and proximate an outer edge 15 of the second seed disc 11. The plurality of second seed pockets 13 are not equidistantly spaced relative to adjacent second seed pockets 15. The method may further include placing the seeds of a first seed type 34 in the first seed meter 32, placing the seeds of a second seed type 35 in the second seed meter 33, and moving the seed planter 30 across the field such that seeds of both seed types are dispensed in a single row.

In at least another embodiment of the present invention, the method of planting a field with a seed planter 30 may include dispensing seeds of a first seed type 34 into a cultivated row with a first seed meter 32 including a plurality of first seed pockets 12 for receiving the seeds of a first seed type to be dispensed. The method may further include dispensing seeds of a second seed type 35 into the cultivated row with a second seed meter 33 including a plurality of second seed pockets 13 for receiving the seeds of a second seed type to be dispensed. The arc length between at least one of the second seed pockets 13 and a next radially-spaced second seed pocket 13 in a first radial direction is different from the arc length between said second seed pocket 13 and a next radially-spaced second seed pocket 13 in a second radial direction opposite the first radial direction.

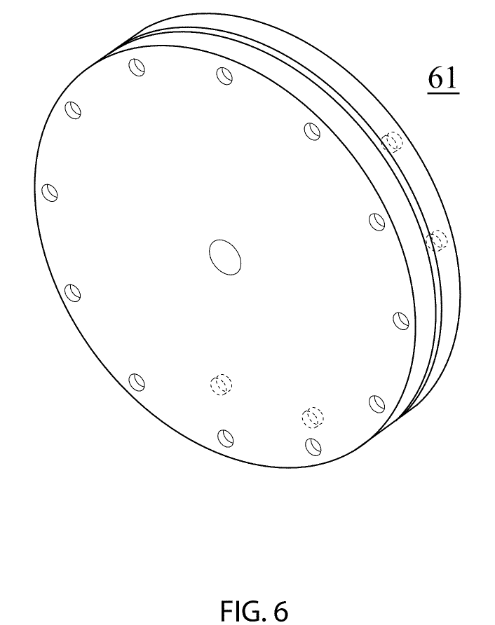

In at least another embodiment of the present invention, the system for planting a field may include a seed planter 30 with a first seed meter 32 and a second seed meter 33. The first seed meter 32 may include a first seed disc 10 with a plurality of first seed pockets 12 circumferentially disposed and proximate an outer edge 14 of the first seed disc 10. The plurality of first seed pockets 12 may be equidistantly spaced relative to adjacent first seed pockets 12. The second seed meter 33 may include a second seed disc 11 with a plurality of second seed pockets 13 circumferentially disposed and proximate an outer edge 15 of the second seed disc 11. The plurality of second seed pockets 13 are not equidistantly spaced relative to adjacent second seed pockets 15. The seed pockets 13 may be unequally spaced. The seed pockets 13 may be non-fractionally spaced as well, so that the distance (or angle of arc) between various seed pockets 13 are not multiples of each other. The seed planter 30 may be further configured to dispense the plurality of seeds of a first seed type 34 from the first seed disc 10 and a plurality of seeds of a second seed type 35 from the second seed disc 11 in a single row. In an alternative embodiment, the two seed discs 10, 11 may be integrated into a unitarily-formed seed disc 61 having one side receiving the first seed type 34 and an opposing side receiving a second seed type 35, as depicted in FIG. 6. The unitarily-formed seed disc 61 may be fed seeds from both the first and second seed meters 32, 33. For example, the middle track of the seed disc may be connected to tunnels to each of the seed pockets 13, 15 so that air suction may be provided to the middle track and be used to secure the seeds 41, 42 within each of the seed pockets 13, 15.

In at least another embodiment of the present invention, they system for planting a field may include a first seed meter 32 for dispensing seeds of a first seed type 34 into a cultivated row. The first seed meter 32 may include a plurality of first seed pockets 12 for receiving the seeds of a first seed type 34. The system may further include a second seed meter 33 for dispensing seeds of a second seed type 35 into a cultivated row. The second seed meter 33 may include a plurality of second seed pockets 13 for receiving the second seeds. The arc length between at least one of the second seed pockets 13 and a next radially-spaced second seed pocket 13 in a first radial direction is different from the arc length between said second seed pocket 13 and a next radially-spaced second seed pocket 13 in a second radial direction opposite the first radial direction.

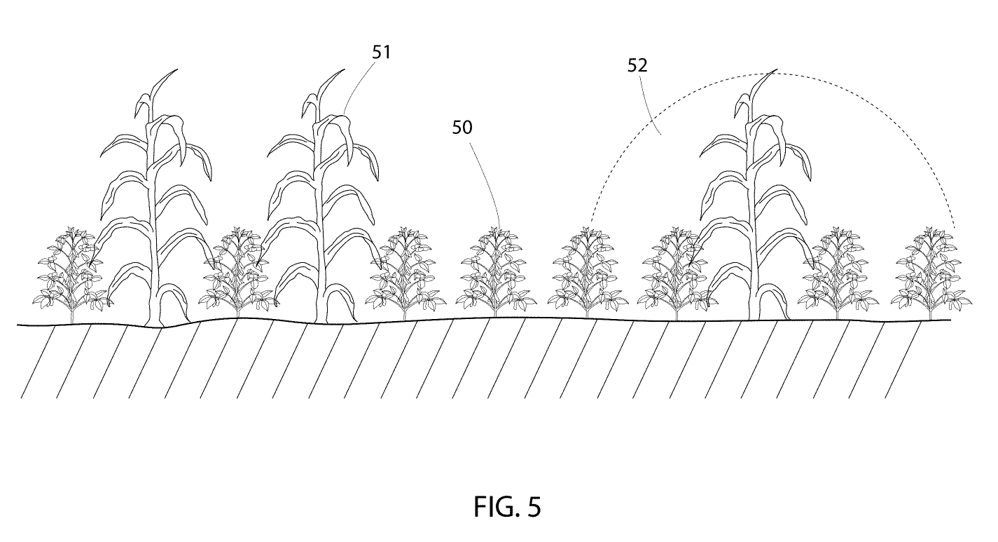

Referring now to FIGS. 4 and 5, the seed planter may be moved across the field 40 a plurality of times to create a plurality of rows throughout the entire field 40. Seeds of a first seed type 41 can be dispensed within rows at equidistant intervals, and seeds of a second type 42 can be dispensed within rows at non-equidistant intervals. The positions of the seeds of a second type 42 within a row can vary amongst the plurality of rows. The arrangement of seeds of a first seed type 41 and seeds of a second type 42 throughout field 40 created by the systems and methods of the present invention are advantageous over conventional row intercropping.

Numerous methods of planting an entire field may be envisioned by one skilled in the art. As a single row is seeded, or multiple rows are seeded simultaneously, eventually the planter 30 reaches the end of the field and must pivot around to begin planting the adjacent rows. During the pivot, the seed discs 10, 11 may be manually or automatically repositioned. The repositioning would allow the rows to be planted uniformly throughout the entire row. For example, but limited to, the seed discs 10, 11 of each row would change positions so that the seed disc 10, 11 on the right when planting the row in one direction would be on the left when planting in the opposite direction, and vice versa. In alternative embodiments, where the unitarily-formed seed disc 61 is used, the disc 13 could be rotated 180 degrees during the pivot to change the positions of the sides of the disc 13.

In some embodiments, the planter 30 may be outfitted with additional seed discs 10, 11 on each end, which may be individually controlled; one or both of the seed discs 10, 11 positioned on the ends may be shut off and on during each pass. For example, but not limited thereto, a first seed disc 10 and a second seed disc 11 may be positioned on the planter 30 in the following arrangement: 11, 10, 11, space, 10, 11, space, 10, 11, 10. On the second pass, the seed disc on the left end becomes the seed disc on the right end, arranged like so: 10, 11, 10, space, 11, 10, space, 11, 10, 11. The planter 30 may be modified before entering the second pass so that the left-most first seed disc 10 and/or the right-most second seed disc 11 may be shut off during the pass. In alternative embodiments, the planter 30 may be arranged in the following manner: 11, space, 10, 11, space, 10, 11, space, 10, 11, space, 10. Any number of arrangements and controls of the seed discs 10, 11 may be provided to provide for crop patterns desired.

Mixed intercropping may be particularly desirable when trying to increase the yield from a field of two different crops. Mixing tall, heat-resistant plants 51, such as a corn plant, in a field of short, heat-intolerant plants 50, such as a soybean plant, may yield several benefits. Tall plants 51 may act as light interceptors, providing short plants 50, particularly short plants 50 with shortened photoperiods, with the shade necessary to activate flowering. Each of the tall, heat-resistant plants 51 may provide a shade zone 43, 52 for surrounding short, heat-intolerant plants 50, effectively lower the daily average temperature and minimizing heat stress to the heat-intolerant plants 50. With conventional row intercropping techniques, in which one row of tall, heat-resistant plants 51 is planted in between several rows of short, heat-intolerant plants 50, tall, heat-resistant plants 51 planted in close proximity to one another must compete for light, and not all short, heat-intolerant plants 50 receive shade sufficient to activate flowering. Notably, many of the same principles would be applied, albeit possibly in a less-effective manner, if plants 50, 51 of the same or similar height were planted together.

The arrangement of seeds of a first seed type 41 and seeds of a second type 42 throughout field 40 created by the systems and methods of the present invention provides a distribution of tall, heat-resistant plants 51 throughout a field of short, heat-intolerant plants 50 that maximizes the area covered by shade zones 43, 52 without reducing the area planted with short, heat-intolerant plants 50, and minimizes the number of tall, heat-resistant plants 51 in the shade zones 43, 52 of other tall, heat-resistant plants 51.

Thus, in some embodiments of the invention, the seeds of a first seed type 34 are short, heat-intolerant plants 50 and seeds of a second seed type 35 are tall, heat resistant plants 51. In still other embodiments, the seeds of a first seed type 34 are soybean seeds and seeds of a second seed type 35 corn seeds.

In one example of using the present invention, short soybean plants and tall corn plants were planted using a commercially available YSET SELECT™ seed planter and seed discs according to the present invention. The distribution of tall corn plants throughout the field of soybean plants resulted in 12 hours of direct light to tall corn plants, 6 hours of direct light to short soybean plants, 6 hours of 50% light to short soybean plants, and 12 hours of darkness for both plants. The corn plants were harvested first using a combine harvester without damaging the short soybean plants, and short soybean plants were subsequently harvested. Soybean yield per acre can be increased by 25% or more compared to United States Department of Agriculture estimates for average soybean yield per acre in the United States, plus modest yields of corn were produced on the same acre. In some embodiments of the present invention, both plant types 50, 51 may be harvested in a single pass simultaneously, allowing for the seeds to be separated after harvesting, such as by a vibrational seed separator.

Many changes and modification could be made to the invention without departing from the spirit thereof. The scope of these changes will become apparent from the appended claims.

What is claimed is:

1. A method of planting a field with a seed planter comprising:
moving the seed planter across the field such that seeds of a first seed type and seeds of a second seed type are both dispensed in a single row,
wherein a first seed disc of the seed planter is configured to dispense seeds of the first seed type equidistant relative to adjacent seeds of the first seed type, and
wherein a second seed disc is configured to dispense the seeds of the second seed type not equidistant relative to adjacent seeds of the second seed type.

2. The method of claim 1, wherein the seed discs are repositioned after each single row is planted.

3. The method of claim 1, wherein the seeds of a second type are dispensed into positions within each of the plurality of cultivated rows, and wherein the positions vary amongst a plurality of cultivated rows.

4. The method of claim 1, wherein the seeds of the first seed type are short, heat-intolerant plants, and wherein the seeds of a second seed type are tall, heat-resistant plants.

5. The method of claim 1, wherein the seeds of a first seed type are soybean seeds, and wherein the seeds of a second seed type are corn seeds.

6. The method of claim 1, further comprising:
affixing the first seed disc to a first seed meter, wherein the first seed disc defines a plurality of first seed pockets equidistantly and circumferentially disposed and proximate an outer edge thereof;
affixing a rotatable second seed disc to a second seed meter, wherein the second seed disc defines a plurality of second seed pockets non-equidistantly and circumferentially disposed and proximate an outer edge thereof;
placing seeds of the first seed type in the first seed meter; and
placing seeds of the second seed type in the second seed meter.

7. The method of claim 6, wherein the seed discs are repositioned after each single row is planted.

8. The method of claim 6, wherein the seeds of a second seed type are dispensed into positions within each of the plurality of rows, and wherein the positions vary amongst a plurality of rows.

9. The method of claim 6, wherein the seeds of the first seed type are short, heat-intolerant plants, and wherein the seeds of a second seed type are tall, heat-resistant plants.

10. The method of claim 6, wherein the seeds of a first seed type are soybean seeds, and wherein the seeds of a second seed type are corn seeds.

11. A method of planting a field with a seed planter comprising:
dispensing seeds of a first seed type into a cultivated row with a first seed meter that defines a plurality of first seed pockets for receiving the seeds of a first seed type to be dispensed;
dispensing seeds of a second type into the cultivated row with a second seed meter that defines a plurality of second seed pockets for receiving the seeds of a second type to be dispensed;
wherein the arc length between at least one of the second seed pockets and a next radially-spaced second seed pocket in a first radial direction is different from the arc length between said second seed pocket and a next radially-spaced second seed pocket in a second radial direction opposite the first radial direction.

12. The method of claim 11, wherein the seeds of a second type are dispensed into positions within each of the plurality of cultivated rows, and wherein the positions vary amongst a plurality of cultivated rows.

13. The method of claim 11, wherein the seeds of a first seed type are short, heat-intolerant plants, and wherein the seeds of a second type are tall, heat-resistant plants.

14. The method of claim 11, wherein the seeds of a first seed type are soybean seeds, and wherein the seeds of a second type are corn seeds.

15. A system for planting a field comprising:
a first seed meter including a first seed disc with a plurality of first seed pockets circumferentially disposed proximate an outer edge of the first seed disc, wherein the plurality of first seed pockets are equidistantly spaced relative to adjacent first seed pockets;
a second seed meter including a second seed disc with a plurality of second seed pockets circumferentially disposed proximate an outer edge of the second seed disc, wherein the plurality of second seed pockets are not equidistantly spaced relative to the adjacent second seed pockets,
wherein the first seed disc is configured to equidistantly dispense a plurality of seeds of a first seed type in a row, and the second seed disc is configured to non-equidistantly dispense a plurality of seeds of a second type in the row.

16. They system of claim 15, wherein the seeds of the first seed type are short, heat-intolerant plants, and wherein the seeds of a second seed type are tall, heat-resistant plants.

17. The system of claim 15, wherein the seeds of a first seed type are soybean seeds, and wherein the seeds of a second seed type are corn seeds.

18. A system for planting a field comprising:
a first seed meter for dispensing seeds of a first seed type into a cultivated row, the first seed meter defining a plurality of first seed pockets for receiving the seeds of a first seed type;
a second seed meter for dispensing seeds of a second type into the cultivated row, the second seed meter defining a plurality of second seed pockets for receiving the seeds of a second type;
wherein the arc length between at least one of the second seed pockets and a next radially-spaced second seed pocket in a first radial direction is different from the arc length between said second seed pocket and a next radially-spaced second seed pocket in a second radial direction opposite the first radial direction.

19. They system of claim 18, wherein the seeds of a first seed type are short, heat-intolerant plants, and wherein the seeds of a second type are tall, heat-resistant plants.

20. The system of claim 18, wherein the seeds of a first seed type are soybean seeds, and wherein the seeds of a second type are corn seeds.
